(19) United States
(12) Patent Application Publication
(10) Pub. No.: US 2025/0342681 A1
(43) Pub. Date: Nov. 6, 2025

(54) METHODS AND DEVICES FOR REMOTE SENSING IMAGE CLASSIFICATION USING QUANTUM PIXEL MATRIX ENTANGLEMENT

(71) Applicant: GUILIN UNIVERSITY OF TECHNOLOGY, Guilin (CN)

(72) Inventors: Guoqing ZHOU, Guilin (CN); Lihuang QIAN, Guilin (CN)

(73) Assignee: GUILIN UNIVERSITY OF TECHNOLOGY, Guilin (CN)

(21) Appl. No.: 19/200,623

(22) Filed: May 6, 2025

(30) Foreign Application Priority Data
May 6, 2024 (CN) 202410547281.6

(51) Int. Cl. G06V 10/764; G06N 10/20; G06V 10/74

(52) U.S. Cl. CPC G06V 10/764; G06N 10/20; G06V 10/761

(57) ABSTRACT

A method and device for remote sensing image classification using quantum pixel matrix entanglement is provided. The method comprises: preprocessing an acquired raw remote sensing image to obtain image data containing multiband fusion; and calculating a pixel matrix entanglement coefficient μ and a Euclidean distance d between a cluster center and other pixel matrices based on a preprocessed remote sensing image, performing an iterative self-organizing classification on remote sensing image data based on the pixel matrix entanglement coefficient and a Euclidean distance threshold, and obtaining remote sensing image classification results.

### CROSS-REFERENCE TO RELATED APPLICATIONS

This application claims priority to Chinese application No. 202410547281.6 filed on May 6, 2024, the entire contents of which are incorporated herein by reference.

### TECHNICAL FIELD

The present disclosure relates to the field of image classification, and in particular relates to a method and device for remote sensing image classification using quantum pixel matrix entanglement.

### BACKGROUND

Image classification technology, as one of the key technologies of remote sensing technology, greatly affects information extraction and wide application of a remote sensing image. However, traditional unsupervised classification manners including ISODATA, K-Means, SOM, and FCM only consider a Euclidean distance between pixels of the remote sensing image, and do not fully consider rich spectral information of the remote sensing image, which makes it difficult to ensure the classification accuracy, and there is a lot of room for improvement. In order to fully take into account the rich spectral information of the remote sensing image, and to overcome the problem of low classification accuracy of traditional unsupervised classification manners, a new unsupervised classification manner is needed to provide a higher accuracy solution for unsupervised classification of the remote sensing image.

In view of the foregoing, it is desired to provide a method and device for remote sensing image classification using quantum pixel matrix entanglement, which is based on a preprocessed remote sensing image, and uses a pixel matrix entanglement coefficient and the Euclidean distance as a basis of classification to realize self-organizing cluster of images to fully exploit and utilize pixel matrix entanglement features, pixel matrix spectral features, and pixel matrix distance features embedded under a pixel level of the remote sensing image to accurately classify the images, aiming at solving the problem of low accuracy in performing unsupervised classification of the remote sensing image.

### SUMMARY

Some embodiments of the present disclosure provide a method for remote sensing image classification using quantum pixel matrix entanglement, comprising:
preprocessing an acquired raw remote sensing image to obtain image data containing multiband fusion;
calculating a pixel matrix entanglement coefficient μ and a Euclidean distance d between a cluster center and other pixel matrices based on a preprocessed remote sensing image, performing an iterative self-organizing classification on remote sensing image data based on the pixel matrix entanglement coefficient and a Euclidean distance threshold, and obtaining remote sensing image classification results.

In some embodiments, the preprocessing an acquired raw remote sensing image includes radiometric correction, atmospheric correction, geometric correction, image cropping, and image fusion.

In some embodiments, the calculating a pixel matrix entanglement coefficient μ and a Euclidean distance d between a cluster center and other pixel matrices based on a preprocessed remote sensing image, performing an iterative self-organizing classification on remote sensing image data based on the pixel matrix entanglement coefficient and a Euclidean distance threshold, and obtaining remote sensing image classification results further includes:
calculating, based on the preprocessed remote sensing image, quantum states of pixel matrices corresponding to images of individual bands, and calculating a superposition state of the quantum states of the pixel matrices of the individual bands based on a count of bands in the raw remote sensing image;
determining a count of classes of classified features based on a classification requirement of the remote sensing image;
performing, based on the count of classes of classified features, the iterative self-organizing classification on the remote sensing image data to obtain the remote sensing image classification results.

In some embodiments, the calculating, based on the preprocessed remote sensing image, quantum states of pixel matrices corresponding to images of individual bands, and calculating a superposition state of the quantum states of the pixel matrices of the individual bands based on a count of bands in the raw remote sensing image further includes:
starting from a pixel of the preprocessed remote sensing image, transforming all pixels into quantum pixel matrices under three-dimensional orthogonal basis vectors in a Hilbert space, and calculating a corresponding quantum state |ϕₚ [symbol] ;
calculating, based on a quantum state |ϕₚ [symbol] of each pixel matrix, a correspondence between the quantum state |ϕₚ [symbol] of the each pixel matrix and a red grayscale value G_{R}, a green grayscale value G_{G}, and a blue grayscale value G_{B} of the each pixel matrix;
determining a count of bands u in the raw remote sensing image;
calculating the superposition state |ϕ [symbol] of the quantum states of the pixel matrices of the individual bands based on the count of bands u in the raw remote sensing image.

In some embodiments, the performing, based on the count of classes of classified features, the iterative self-organizing classification on the remote sensing image data to obtain the remote sensing image classification results further includes:
determining an initial cluster center K_{C}, and randomly selecting K pixel matrices as the initial cluster center K_{C};
calculating the pixel matrix entanglement coefficient μ and the Euclidean distance d between the cluster center and the other pixel matrices based on the initial cluster center K_{C};
determining the Euclidean distance threshold based on the classification requirement;
combining pixel matrices with the pixel matrix entanglement coefficient μ of the preprocessed remote sensing image being 0 and the Euclidean distance d being less than a Euclidean distance threshold d′ into a class for performing the iterative self-organizing classification;
updating the cluster center based on a result of the iterative self-organizing classification;
repeating the iterative self-organizing classification until iterations converge to achieve the classification of the remote sensing image.

In some embodiments, the method for remote sensing image classification using quantum pixel matrix entanglement further comprising:
determining an overall difference degree of different types of pixels of the preprocessed remote sensing image;
determining a plurality of different Euclidean distance thresholds based on the classification requirement and the overall degree of determining a plurality of different Euclidean distance thresholds based on the classification requirement and the overall difference degree; wherein the plurality of different Euclidean distance thresholds correspond to a plurality of different preprocessed remote sensing images;
controlling, based on the plurality of different Euclidean distance thresholds, an image classification device to perform the iterative self-organizing classification on the preprocessed remote sensing image, and obtaining the remote sensing image classification results;
determining, based on the remote sensing image classification results, a resolution combination corresponding to a plurality of different types of the remote sensing image classification results, and displaying, by a display device, the remote sensing image classification results based on the resolution combination.

In some embodiments, the determining a plurality of different Euclidean distance thresholds based on the classification requirement and the overall difference degree further comprising:
for each preprocessed remote sensing image,
determining a resolution quality value of the plurality of preset distance thresholds by a display model based on the classification requirement, the overall difference degree, and the plurality of preset distance thresholds; the display model being a machine learning model;
determining the Euclidean distance threshold corresponding to the preprocessed remote sensing image based on the resolution quality value.

In some embodiments, the plurality of preset distance thresholds are determined based on historical classification results.

In some embodiments, a training of the display model includes:
determining different sets of training samples and corresponding labels of the training samples based on a count of specified classification types;
performing training on the different sets of training samples according to their size.

In some embodiments, the determining an initial cluster center K_{C} further includes:
determining, based on the preprocessed remote sensing image, a red grayscale value, a green grayscale value, and a blue grayscale value of the each pixel matrix in the preprocessed remote sensing image;
determining a ratio of different types of pixels of the preprocessed remote sensing image based on the red grayscale value, the green grayscale value, and the blue grayscale value of each pixel matrix;
determining a count of updated initial cluster center K_{C} based on the ratio of the different types of pixels;
In some embodiments, the method further comprises:
controlling an image classification device to perform the iterative self-organizing classification on the preprocessed remote sensing image based on the count of updated initial cluster center K_{C}.

In some embodiments, the determining a count of updated initial cluster center K_{C} based on the ratio of the different types of pixels further comprises:
sorting in descending order based on the ratio of the different types of pixels;
designating a count of predicted classification types whose ordering is prior to a predetermined preset ranking as the count of updated initial cluster center K_{C} based on the classification requirement.

In some embodiments, the count of pixel types is related to an image richness degree of the preprocessed remote sensing image; and the pixel types are determined based on historical classification results.

In some embodiments, the method further comprises:
determining an updated control parameter based on the remote sensing image classification results, the control parameter including a flight altitude and a flight speed;
controlling, based on the updated control parameter, an image acquisition device to fly at an updated flight speed to an updated flight altitude.

In some embodiments, the method further comprises:
determining an area and a location of a fire risk region based on the remote sensing image classification results;
determining an inspection path and an inspection speed of an inspection device based on the area and the location of the fire risk region;
controlling the inspection device to inspect the fire risk region at the inspection speed based on the inspection path.

Some embodiments of the present disclosure provide a device for remote sensing image classification using quantum pixel matrix entanglement, comprising:
a data preprocessing module configured to preprocess an acquired raw remote sensing image to obtain remote sensing image data containing multiband fusion;
a matrix calculation module configured to calculate, based on the preprocessed remote sensing image, a quantum states |ϕₚ [symbol] of a pixel matrix matrices corresponding to the images of t individual bands;
a quantum state superposition module configured to calculate a superposition states |ϕ [symbol] of the quantum states of the pixel matrices for each of the individual bands based on a count of bands u in the raw remote sensing image;
a cluster center setting module configured to randomly select K pixel matrices as the initial cluster centers K_{C}, for an iterative self-organizing classification according to a classification requirement;
an entanglement coefficient calculation module configured to calculate a pixel matrix entanglement coefficient μ between a cluster center and the other pixel matrices based on the cluster center;
a self-organizing classification module configured to calculate, based on the cluster center, the pixel matrix entanglement coefficient μ and a Euclidean distance d between the cluster center and the other pixel matrices, and to perform the iterative self-organizing classification of remote sensing image data based on the pixel matrix entanglement coefficient and a Euclidean distance threshold to obtain remote sensing image classification results.

In some embodiments, the self-organizing classification module includes:
a distance calculation module configured to calculate a Euclidean distance d, between the cluster center and the other pixel matrices based on the cluster center;
a threshold determination module configured to determine the Euclidean distance threshold based on the classification requirement;
a classification module configured to perform the iterative self-organizing classification of the remote sensing image data based on the pixel matrix entanglement coefficient and the Euclidean distance threshold, to obtain the remote sensing image classification results.

In some embodiments, the device for remote sensing image classification using quantum pixel matrix entanglement, further comprising:
a first control module configured to determine an updated control parameter based on the remote sensing image classification results, the control parameter including a flight altitude and a flight speed; and control, based on the updated control parameter, an image acquisition device to fly at an updated flight speed to an updated flight altitude.

In some embodiments, the device further comprises:
a second control module configured to determine an area and a location of a fire risk region based on the remote sensing image classification results; determine an inspection path and an inspection speed of an inspection device based on the area and the location of the fire risk region; and control the inspection device to inspect the fire risk region at the inspection speed based on the inspection path.

Some embodiments of the present disclosure provide a computer-readable storage medium, the computer-readable storage medium storing program codes, when the program codes are executed by a processor, a method for remote sensing image classification using quantum pixel matrix entanglement is realized, wherein the method comprises:
preprocessing an acquired raw remote sensing image to obtain image data containing multiband fusion;
calculating a pixel matrix entanglement coefficient μ and a Euclidean distance d between a cluster center and other pixel matrices based on a preprocessed remote sensing image, performing an iterative self-organizing classification on remote sensing image data based on the pixel matrix entanglement coefficient and a Euclidean distance threshold, and obtaining remote sensing image classification results.

Some embodiments of the present disclosure provide a computing device including: one or more processors, memory, and one or more programs, wherein the one or more programs are stored in the memory and configured to be executed by the one or more processors, the one or more programs include instructions for performing any of the methods described in any one of the methods.

### BRIEF DESCRIPTION OF THE DRAWINGS

In order to more clearly illustrate the technical solutions of the embodiments of the present application, the accompanying drawings required to be used in the embodiments of the present application will be briefly described hereinbelow, and it should be understood that the following accompanying drawings illustrate only some of the preferred embodiments of the present application, and therefore should not be regarded as limiting the scope of the present application. It should be understood that the following drawings illustrate only some of the preferred embodiments of the present application, and therefore should not be regarded as a limitation of the scope of the present application, and that other relevant drawings may be obtained from these drawings by a person of ordinary skill in the art, without the need for creative labor. In the accompanying drawings shown:

FIG. 1 is a flowchart illustrating an exemplary method for remote sensing image classification using quantum pixel matrix entanglement according to some embodiments of the present disclosure.

FIG. 2 is a flowchart illustrating an exemplary process of determining a resolution combination corresponding to a remote sensing image according to some embodiments of the present disclosure.

FIG. 3 is a block diagram illustrating a structure of a device for remote sensing image classification using quantum pixel matrix entanglement according to some embodiments of the present disclosure.

### DETAILED DESCRIPTION

In order to facilitate understanding of the present application, the present application will be described more fully below with reference to the relevant accompanying drawings. Several embodiments of the present application are given in the accompanying drawings. However, the present application can be realized in many different forms and is not limited to the embodiments described herein. Rather, these embodiments are provided to make the disclosure of the present application more thorough and comprehensive.

It should be noted that the technical and scientific terms used herein are intended only to describe specific embodiments and are not intended to limit the exemplary embodiments according to the present invention. As used herein, the singular form is also intended to include the plural form, unless the context otherwise clearly indicates, and it should be understood, furthermore, that when used in this specification, the terms “comprises” and/or “includes” indicate the presence of features, steps, operations, devices, components, and/or combinations thereof.

In order to better understand the innovations of the present disclosure and its advantages in the field of remote sensing image classification, the following may briefly review the prior art and draw out specific methods and improvements of the present disclosure. Guo Yunkai et al. proposed a remote sensing image classification method fusing an enhanced fuzzy cluster genetic algorithm and ISODATA algorithm, which effectively solved the problem of randomness of an initial value of cluster by introducing an individual fitness function. However, the classification process relies on a distance feature between samples. Li Yu et al. proposed a hyperspectral image classification method based on weighted K-Means cluster of band image statistics, which calculates band weights to rationally utilize correlation information of individual bands, while the method does not comprehensively consider the spatial and spectral information of remote sensing images. Huang Hui et al. proposed a classification method combining fractal texture and gravitational self-organizing neural network (gSOM) to solve the problem of difficult identification and extraction of seismic targets in high spatial resolution remote sensing image, which fuses the spectral and texture features of the image, while the cluster results need to be further screened and optimized. Patra et al. proposed a Self-Organizing Mapping (SOM) neural network and Support Vector Machine (SVM) based image classifier, which exploits the topological properties of the SOM method to train the samples and speeds up the convergence of the classification process, while the spectral information of the images needs to be further utilized. Gadhiya et al. proposed a global K-Means synthetic aperture radar (SAR) image classification method, which introduces a superpixel-driven optimized Wishart network to achieve efficient utilization of spatial features of neighboring pixels and obtain relatively great classification results. Saman et al. proposed a histogram-based FCM automatic cluster method, which realizes multispectral image cluster based on the band information of the histogram statistics, while the cluster algorithm can be further optimized by combining the spectral and spatial features of the bands. Wang Dongli et al. proposed a feature information extraction method based on multi-temporal remote sensing data, which combines multi-temporal features to realize feature information extraction from remote sensing images. Hongmin Gao et al. proposed a method and device for hyperspectral remote sensing image classification, which realizes the classification of remote sensing images by using spectral and spatial dual-channel attention mechanism. Le Peng et al. proposed a method for high-resolution remote sensing image classification guided by multilevel spatial context features, which realizes image classification based on multi-feature fusion of texture features, geometric features, and spatial context features. Huang et al. proposed an unsupervised adaptive automatic image classification method, which can update the classifier by assuming labels and adaptive data. In view of the deficiencies of the existing techniques in remote sensing image classification, such as limited classification accuracy and failure to adequately fuse multi-source information, the present disclosure proposes a method for remote sensing image classification using quantum pixel matrix entanglement, which aims to overcome limitations of traditional methods and significantly improve the accuracy and efficiency of remote sensing image classification by innovative quantum state computation and iterative self-organizing classification techniques.

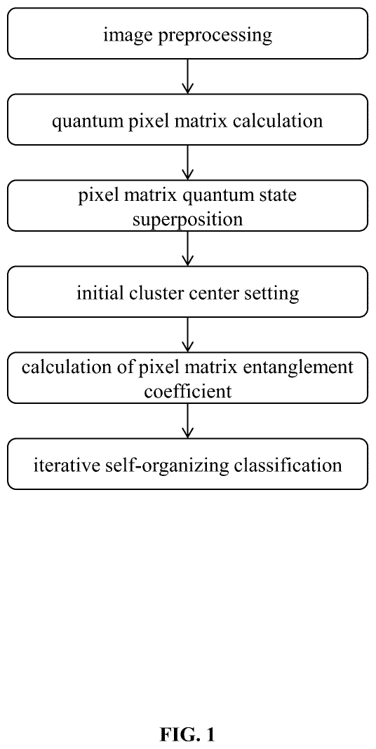

FIG. 1 is a flowchart illustrating an exemplary method for remote sensing image classification using quantum pixel matrix entanglement according to some embodiments of the present disclosure.

Some embodiments of the present disclosure provide a method for remote sensing image classification using quantum pixel matrix entanglement (hereinafter referred to as an image classification method). As shown in FIG. 1, the image classification method includes following operations:

S1: preprocessing an acquired raw remote sensing image to obtain image data containing multiband fusion.

The raw remote sensing image refers to image data that is directly acquired without any processing. In some embodiments, the processor may acquire the raw remote sensing image via satellite. In some embodiments, the processor may also acquire the raw remote sensing image via an image acquisition device such as a drone equipped with a high-resolution camera and sensor. For example, the image acquisition device is controlled to acquire the raw remote sensing image by flying at a preset flight speed to a preset flight altitude based on a control parameter. The control parameter includes a flight speed and a flight altitude, and the preset flight speed and the preset flight altitude may be set by a person skilled in the art based on experience.

In some embodiments, the preprocessing of the acquired raw remote sensing image in operation S1 includes radiometric correction, atmospheric correction, geometric correction, image cropping, image fusion, or the like.

The radiometric correction is configured to remove effects of own errors of the image acquisition device and lighting conditions on the image. The atmospheric correction is configured to remove interference such as atmospheric scattering and absorption to restore an actual reflectivity of features. The geometric correction is configured to correct a geometric distortion of the images due to factors such as an attitude of the image acquisition device or the terrain to match map coordinates. The image cropping is configured to intercept an image portion of a target region to remove extraneous regions in order to reduce the amount of data. The image fusion is configured to combine a plurality of bands or different resolution images to enhance spatial and spectral information.

In some embodiments of the present disclosure, preprocessing operations such as the radiometric correction, the atmospheric correction, the geometric correction, the image cropping, and the image fusion can eliminate noise, atmospheric interference, and geometric aberrations in the image, which enhance spectral characteristics and spatial information of the images, and provide more accurate and clear data basis for subsequent classification analysis, significantly improving classification accuracy and reliability.

S2: calculating a pixel matrix entanglement coefficient μ and a Euclidean distance d between a cluster center and other pixel matrices based on a preprocessed remote sensing image, performing an iterative self-organizing classification on remote sensing image data based on the pixel matrix entanglement coefficient and a Euclidean distance threshold, and obtaining remote sensing image classification results.

The pixel matrix entanglement coefficient is a characteristic parameter that measures a correlation between pixel matrices of different bands.

The Euclidean distance threshold is a distance threshold for determining whether the pixel matrix belongs to the same class. In some embodiments, the Euclidean distance threshold may be preset by a person skilled in the art. More descriptions of the Euclidean distance threshold may be found in later descriptions.

The remote sensing image data refers to image data that is captured by an image acquisition device and is preprocessed. In some embodiments, the remote sensing image data may include image information of Earth's surface, such as spectrums, textures, and shapes of land features.

The iterative self-organizing classification is a process of classifying data automatically by continually and iteratively updating the cluster center.

The remote sensing image classification result refers to a result after recognizing and classifying different feature types in the preprocessed remote sensing image.

More descriptions of classification process may be found in later descriptions.

In some embodiments of the present disclosure, based on the preprocessed remote sensing image, the spectral features of a pixel matrix, entanglement features, Euclidean distance features, and the pixel matrix entanglement coefficient and the Euclidean distance threshold are making full used for unsupervised classification of the remote sensing image, which can greatly improve the classification accuracy, and at the same time improve the accuracy and efficiency of unsupervised classification of remote sensing image, solve the problem of low classification accuracy of traditional classification processes due to reliance on the Euclidean distance only, and provide a new solution for remote sensing image classification that is more accurate and more efficient.

In some embodiments, the S2 further includes following operations:

S21: calculating, based on the preprocessed remote sensing image, quantum states of pixel matrices corresponding to images of individual bands. That is, starting from a pixel of the preprocessed remote sensing image, transforming all pixels into quantum pixel matrices under three-dimensional orthogonal basis vectors in a Hilbert space, and calculating a corresponding quantum state |ϕₚ [symbol] ; and calculating, based on a quantum state |ϕₚ [symbol] of each pixel matrix, a correspondence between the quantum state |ϕₚ [symbol] of the each pixel matrix and a red grayscale value G_{R}, a green grayscale value G_{G}, and a blue grayscale value G_{B} of the each pixel matrix. The formulas involved include:

$$\vert {ϕ}_{p} 〉 = α \vert 1 〉 + β \vert 2 〉 + γ \vert 3 〉 = {[ α , β , γ ]}^{T} ;$$

$$\vert {ϕ}_{p} 〉 = {[ cos ( \frac{{G}_{R}}{255} ) , cos ( \frac{{G}_{G}}{255} ) , cos ( \frac{{G}_{B}}{255} ) ]}^{T} ;$$

|ϕₚ [symbol] denotes a certain quantum pixel matrix p of a quantum state; α, β, γ are characteristic values of |ϕₚ [symbol] , which satisfy a normalization condition, |α|²+|β|²+|γ|²=1; |1 [symbol] , |2 [symbol] , |3 [symbol] are orthogonal characteristic vectors of |ϕₚ [symbol] , which denote three base vectors that are orthogonal to each other in a Hilbert space; G_{R}, G_{G}, G_{B} denote a corresponding red grayscale value, green grayscale value, and blue grayscale value of the pixel matrix, respectively.

The pixel matrix refers to a matrix including spectral values for each pixel in the preprocessed remote sensing image. In some embodiments, each row or column of the pixel matrix represents spectral information of a pixel, and different rows or columns represent the spectral information of different pixels.

The quantum state refers to a mathematical object of a microscopic particle or system state containing all its information.

S22: based on the quantum states of the pixel matrices corresponding to images of individual bands, and calculating a superposition state of the quantum states of the pixel matrices |ϕ [symbol] of the individual bands based on a count of bands in the raw remote sensing image. The equations involved include:

$$\vert ϕ 〉 = {C}_{1} \vert {ϕ}_{P 1} 〉 + {C}_{2} \vert {ϕ}_{P 2} 〉 + ⋯ + {C}_{v} \vert {ϕ}_{P v} 〉 ;$$

$${C}_{v} = [ cos ( \frac{{G}_{{R}_{v}}}{255} ) , cos ( \frac{{G}_{{G}_{v}}}{255} ) , cos ( \frac{{G}_{{B}_{v}}}{255} ) ] ;$$

C₁, C₂, . . . , Cᵥ are characteristic values of |ϕ [symbol] , which satisfy the normalization condition, |C₁|²+|C₂|²+ . . . +|Cᵥ|²=1; v denotes a count of bands in the raw remote sensing image; G_{R}_{ᵥ}, G_{G}_{ᵥ}, G_{B}_{ᵥ} denote a red grayscale value, a green grayscale value, and a blue grayscale value corresponding to the pixel matrices of v, respectively.

The superposition state refers to a linear combination in a plurality of possible states of a quantum system at the same time.

S23: determining a count of classes of classified features based on a classification requirement of the remote sensing image.

The classification requirement refers to data that is pre-input into an image classification device. In some embodiments, the classification requirement may include a predicted classification type (e.g., a farmland, a grassland, a forest, or the like), a classification level (e.g., the same predicted classification type is classified according to a hierarchy), and a classification degree (e.g., strict classification, fuzzy classification, or the like). In some embodiments, the classification requirement may be set in advance by a person skilled in the art.

The classified features refer to different ground objects or geographic elements that need to be identified and distinguished in the classification of remote sensing image, such as a forest, a farmland, a water body, an urban building, or the like.

In some embodiments, the processor may determine a count of categories M of classified features based on the classification requirement of the remote sensing image. For example, the stricter the classification requirement of the remote sensing image, the greater the count of classes of classified features.

S24: performing, based on the count of classes of classified features, the iterative self-organizing classification on the remote sensing image data to obtain the remote sensing image classification results.

In some embodiments of the present disclosure, the pixels of the remote sensing image are transformed into a quantum pixel matrix in the Hilbert space, and quantum states and superposition states of the pixel matrices are computed, which realizes deep mining and fusion of multiband information of the remote sensing image. Meanwhile, the spectral characteristics of pixels (e.g., the red grayscale value, the green grayscale value, and the blue grayscale value) and quantum entanglement properties are fully used to provide a more comprehensive description of the complex relationships between pixels. Through the superposition calculation of quantum states, the feature information in the remote sensing image can be extracted more efficiently, and the accuracy and robustness of the classification can be improved, which especially shows a significant advantage when dealing with complex features and multiband data. In some embodiments, the S24 further includes:

S241: determining an initial cluster center K_{C} based on the count of classes of the classified features, and randomly selecting K pixel matrices as the initial cluster center K_{C}, wherein a count of cluster centers is K. More descriptions of the initial cluster center may be found in later descriptions.

S242: calculating the pixel matrix entanglement coefficient μ between the cluster center and the other pixel matrices based on the initial cluster center K_{C}, wherein |ϕ_{C} [symbol] is a quantum state of a certain cluster center C and |ϕ_{D} [symbol] is a quantum state of a certain pixel matrix D. The involved equations include:

$$\vert {ϕ}_{C} 〉 = a \vert 1 〉 + b \vert 2 〉 + c \vert 3 〉 ;$$

$$\vert {ϕ}_{D} 〉 = x \vert 1 〉 + y \vert 2 〉 + z \vert 3 〉 ;$$

$$μ = ayz - bcx ∘$$

a, b, c are characteristic values of |ϕ_{C} [symbol] ; x, y, z are characteristic values of |ϕ_{D} [symbol] .

S243: calculating the Euclidean distance d between the cluster center and the other pixel matrices based on the initial cluster center K_{C}, performing an iterative calculation based on the Euclidean distance threshold d′ and the pixel matrix entanglement coefficient μ, and automatically performing a splitting and merging operations to update the cluster center

$${K}_{j}^{′} .$$

The involved equations include:

$${d}_{ij} = \sqrt{{\sum }_{a = 1}^{{K}_{p}} {( {p}_{i ( a )} - {K}_{j ( a )} )}^{2}} ( 1 \leq j \leq M ) ;$$

$${K}_{j ( a )}^{′} = \frac{1}{{N}_{p}} {\sum }_{i = 1}^{{K}_{p}} {p}_{i ( a )} ( j ) ( 1 \leq a \leq K ) ;$$

pᵢ₍ₐ₎ denotes a first component of an ith pixel matrix feature vector of the image; Kⱼ₍ₐ₎ denotes a ath component of a cluster center of a jth cluster of the image; Kₚ denotes a count of pixel matrices in the image; Nₚ denotes a count of pixel matrices associated with cluster j.

S244: repeating the iterative self-organizing classification process until a convergence condition is satisfied, the classification of images is completed.

In some embodiments of the present disclosure, by combining the pixel matrix entanglement coefficient and the Euclidean distance to perform the iterative self-organizing classification, quantum entanglement features and spatial distance features among pixels in the remote sensing image can be fully utilized, thereby significantly improving the classification accuracy. Meanwhile, by setting the Euclidean distance threshold and iteratively optimizing the cluster center, the classification granularity and accuracy can be effectively controlled to avoid misclassification, which can ensure the stability and reliability of classification results, and provide an efficient, accurate, and flexible new process for remote sensing image classification.

In some embodiments of the present disclosure, combining the pixel matrix entanglement coefficient and the Euclidean distance to perform the iterative self-organizing classification not only takes into account the quantum entanglement properties between pixels, but also takes into account the spatial distance features, thereby effectively improving the accuracy and reliability of remote sensing image classification. In addition, determining the count of feature classes according to the classification requirement can make the classification process more targeted, which can better meet the needs of different application scenarios and can further enhance the practicability and accuracy of the classification results.

In some embodiments, the determining the initial cluster center K_{C} may further includes: determining, based on the preprocessed remote sensing image, a red grayscale value, a green grayscale value, and a blue grayscale value of the each pixel matrix in the preprocessed remote sensing image; determining a ratio of different types of pixels of the preprocessed remote sensing image based on the red grayscale value, the green grayscale value, and the blue grayscale value of the each pixel matrix; and determining a count of updated initial cluster center K_{C} based on the ratio of the different types of pixels.

In some embodiments, the processor may control an image classification device to perform the iterative self-organizing classification on the preprocessed remote sensing image based on the count of updated initial cluster center K_{C}.

Different types of pixels are pixels classified into different types based on attributes such as spectral features, texture features, or spatial location of the preprocessed remote sensing image. For example, the processor may classify pixels with RGB range values of (233-255, 211-255, 0-33) in the preprocessed remote sensing image as farmland type pixels, and pixels with RGB range values of (173-193, 109-216, 156-230) as water body type pixels.

In some embodiments, the processor may classify pixels within a certain range of pixel RGB values as a same type of pixels based on historical classification results for the same geographic region. For example, there is farmland in a particular geographic region, and the processor may classify pixels within a range of pixel RGB values with a predicted classification type of farmland in the historical classification results of the particular geographic region as the farmland type pixels. The historical classification result refers to a previous classification result for the remote sensing image after the classification process. In some embodiments, the processor may obtain the historical classification results directly from the memory.

In some embodiments, the processor may determine a ratio of different types of pixels based on the grayscale value of each pixel of the same type. For example, the preprocessed remote sensing image has a total of 256 pixels, and the processor may estimate that there are 64 pixels of a certain predicted classification type (e.g., farmland) based on the historical classification results, and the ratio of pixels of that type is 64/256, which is 0.25.

In some embodiments, the processor may determine the count of updated initial cluster center K_{C} based on the ratio of the different types of pixels by a preset rule. The preset rule may include determining a count of predicted classification types with a ratio being greater than a preset ratio threshold as the count of updated initial cluster center K_{C}.

In some embodiments, the processor may also sort in descending order based on the ratio of the different types of pixels; and designate a count of predicted classification types whose ordering is prior to a preset ranking as the count of updated initial cluster center K_{C} based on the classification requirement. The preset ranking may be set by a person skilled in the art based on experience.

In some embodiments, the processor may also determine, based on a classification level and the count of predicted classification types whose ordering is prior to the preset ranking, by a first preset algorithm, the count NK_{C} of updated initial cluster center K_{C}. The first preset algorithm may include:

$${NK}_{C} = {T}_{1} \times {L}_{1} + {T}_{2} \times {L}_{2} + ⋯ + {T}_{n} \times {L}_{n} ;$$

T is the count of predicted classification types whose ordering is prior to the preset ranking, and L is the classification level. More descriptions of the classification requirement, the predicted classification type, and the classification level may be found in above descriptions.

In some embodiments, the processor may further determine, in conjunction with a classification degree for each of the predicted classification types and a specified difference degree corresponding to the specified classification types, the count NK_{C} of updated initial cluster center K_{C}. An exemplary equation is:

$${NK}_{C} = {T}_{1} \times {L}_{1} \times {N}_{1} + {T}_{2} \times {L}_{2} \times {N}_{2} + ⋯ + {T}_{n} \times {L}_{n} \times {N}_{n} ;$$

N is a classification coefficient. In some embodiments, the classification coefficient is a preset value, and the smaller the specified difference degree of the specified classification type, the larger the classification coefficient. For example, an equation for calculating the classification coefficient N, may be:

$$N = B + {e}^{\frac{- S}{\overline{O}}}$$

B is a baseline categorical value, S is a specified difference degree, and Ō is a mean value of an overall difference degree. More descriptions of the specified classification type, the specified difference degree, and the overall difference degree may be found in later descriptions.

In some embodiments of the present disclosure, by sorting different types of pixels in ascending order according to the ratio of different types of pixels and selecting the count of predicted classification types with the top order as the count of the initial cluster center in conjunction with the classification requirement, it is possible to determine the count of the initial cluster center in a more scientific manner. This manner not only improves the accuracy and efficiency of the classification, but also enhances the adaptability of the classification process to different remote sensing image data, and especially when dealing with complex scenarios, it is able to better reflect the distribution characteristics of the feature types, and to enhance the overall classification performance and reliability of the results.

The image classification device refers to a device that automatically recognizes and distinguishes different feature types in the remote sensing image.

In some embodiments, the processor may control the image classification device to perform, based on the count of updated initial cluster center K_{C}, the iterative self-organizing classification of the preprocessed remote sensing image by the pixel matrix entanglement coefficient and the Euclidean distance threshold. More on the pixel matrix entanglement coefficient, the Euclidean distance threshold, and the iterative self-organizing classification may be found in FIG. 1 and related descriptions.

In some embodiments of the present disclosure, by determining the ratio of different types of pixels based on the RGB values of the pixels, and dynamically adjusting the count of the initial cluster center accordingly, it is possible to more accurately reflect the distribution of different types of features in the remote sensing image. Setting and updating the count of the initial cluster center for different remote sensing images can shorten a count of iterative updates, which can improve a classification efficiency of the remote sensing image and reduce the amount of data processing, to enhance the adaptability of the classification process to different image data, especially for processing complex or highly image richness degree of the remote sensing image, which can better capture the diversity of feature types, thus improve the overall classification performance and reliability of the results.

In some embodiments, the count of pixel types correlates to an image richness degree of the preprocessed remote sensing image, wherein the pixel types are determined based on historical classification results.

The pixel type refers to a result of categorizing pixels in remote sensing images into different feature types (e.g., a farmland, a forest, a water body, etc.).

The image richness degree reflects a diversity of different types of pixels in the preprocessed remote sensing image. In some embodiments, the count of pixel types positively correlates with the image richness degree of the preprocessed remote sensing image. The greater the image richness degree, the greater the count of pixel types.

In some embodiments, the processor may retrieve a plurality of historical classification results in the same geographic region at the same period of time from the memory directly; determine pixel ranges of pixel RGB values for different predicted classification types based on the plurality of historical classification results, e.g., the processor may obtain pixel ranges of pixel RGB values for a certain predicted classification type (e.g., the farmland) directly from the plurality of historical classification results; determine different types of pixels based on an overlap rate of the pixel ranges of the different predicted classification types of the plurality of historical classification results, determining different types of pixels; and based on a preset overlap rate, determine pixels with an overlap rate of the pixel ranges that is greater than a preset overlap rate as pixels of the same type, and use a corresponding pixel range as a range of pixel RGB values of the corresponding pixel type.

The overlap rate refers to a ratio of the range of pixel RGB values that overlap for a particular type (e.g., the farmland) among the plurality of historical classification results from a plurality of preprocessed remote sensing images. For example, in the historical classification results of 100 preprocessed remote sensing images, if 80 pixels for farmland types are within the same RGB value range, the overlap rate is 80%. In some embodiments, the preset overlap rate may be set empirically by a person skilled in the art.

In some embodiments of the present disclosure, by associating the count of pixel types with the image richness degree of the remote sensing image and determining pixel types based on the plurality of historical classification results, the diversity and complexity of feature types in the image can be more accurately reflected. This not only improves the relevance and accuracy of the classification, but also enhances the adaptability of the classification method to different types of remote sensing images, which can further improve the reliability and practicality of the classification results.

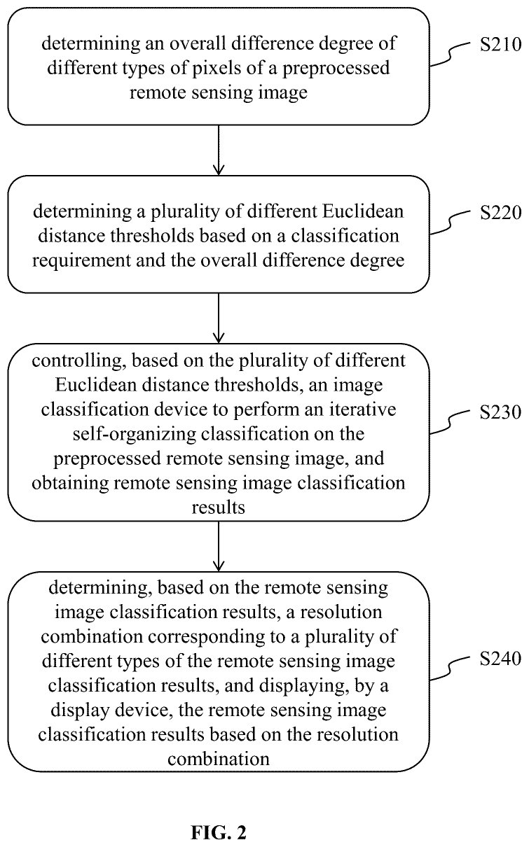

FIG. 2 is a flowchart illustrating an exemplary process of determining a resolution combination corresponding to a remote sensing image according to some embodiments of the present disclosure. As shown in FIG. 2, a process 200 may include the following operations. In some embodiments, process 200 may be executed by a processor.

S210: determining an overall difference degree of different types of pixels of the preprocessed remote sensing image. More descriptions of the different pixel types may be found in the above descriptions.

The overall difference degree refers to a composite measure of differences in characteristics between different types of pixels in the preprocessed remote sensing image. In some embodiments, the overall difference degree between different types of pixels reflects a magnitude of the difference in pixel RGB values of the different types of pixels.

In some embodiments, the processor may determine the overall difference degree between different types of pixels based on differences in boundary values of the ranges of pixel RGB values of the different types of pixels. For example, the processor may obtain the overall difference degree between the ranges of pixel RGB values of type A and type B based on a lower limit of the range of pixel RGB values of type A and an upper limit of the range of pixel RGB values of type B by calculating a vector difference (i.e., a vector distance) between the two.

S220: determining a plurality of different Euclidean distance thresholds based on a classification requirement and the overall difference degree. The plurality of different Euclidean distance thresholds correspond to the plurality of different preprocessed remote sensing images.

In some embodiments, the processor may determine, based on the overall difference degree of the different types of pixels of each preprocessed remote sensing image and the classification requirement, a specified difference degree of a specified classification type; and determine, based on the specified difference degree, a corresponding Euclidean distance threshold for each preprocessed remote sensing image.

The specified classification type refers to a feature type that needs to be focused on and accurately classified according to the preset requirement. For example, when focusing on a type of regions prone to fire, the specified classification type is a forest. The specified classification type may be set in advance by a person skilled in the art.

The specified difference degree refers to a difference in pixel RGB values between pixels of the specified classification type and pixels of other types, such as a difference in pixel RGB values between a forest and a farmland.

In some embodiments, the processor may calculate, based on the overall difference degree of different types of pixels of each preprocessed remote sensing image and the classification requirement, by obtaining pixel RGB values corresponding to the specified classification type with pixel RGB values of other classification types, the specified difference degree of the specified classification type. For example, in response to the existence of a plurality of specified classification types, the processor may obtain the specified difference degree by calculating an average of the differences in the pixel RGB values of the plurality of specified classification types from the other classification types.

In some embodiments, the processor may determine, based on the specified degree of variation, a corresponding Euclidean distance threshold for each preprocessed remote sensing image by a second preset algorithm. The second preset algorithm may include:

$${d}_{1} = {d}_{0} * {e}^{\frac{- S}{\overline{O}}}$$

d₁ is a matching Euclidean distance threshold; d₀ is a baseline Euclidean distance threshold; s is the specified difference degree; Ō is a mean of the overall difference degree.

In some embodiments, the processor may obtain the plurality of Euclidean distance thresholds by calculating a corresponding Euclidean distance threshold for each preprocessed remote sensing image.

In some embodiments, the processor determines a plurality of different Euclidean distance thresholds based on the classification requirement and the overall difference degree, and may further include: for each the preprocessed remote sensing image, determining a resolution quality value of the plurality of preset distance thresholds by a display model based on the classification requirement, the overall difference degree, and the plurality of preset distance thresholds; the display model being a machine learning model; and determining the Euclidean distance threshold corresponding to the preprocessed remote sensing image based on the resolution quality value.

The preset distance threshold refers to a preset fixed distance value configured to judge the similarity of pixels or data points during a classification or cluster process. In some embodiments, the preset distance threshold may be set empirically by a person skilled in the art. In some embodiments, the processor may determine a plurality of preset distance thresholds based on the historical classification results by the plurality of Euclidean distance thresholds that satisfy the classification requirement in the historical classification results.

The resolution quality value refers to a quantitative indicator configured to assess the superiority or inferiority of the preset distance threshold in classification or display performance.

In some embodiments, the display model may be a machine learning model, such as one or more combination of a Neural Network (NN) model or other customized models.

In some embodiments, inputs to the display model may include a set consisting of the overall difference degree of different types of pixels of each preprocessed remote sensing image, the classification requirement, and the plurality of preset Euclidean distance thresholds, and outputs of the display model may be resolution quality values of the plurality of preset Euclidean distance thresholds.

In some embodiments, the display model may be trained based on a large count of training samples with labels.

In some embodiments, the training samples and labels may be obtained based on historical data. The training samples may include a set consisting of a sample overall difference degree, a sample classification requirement, and a plurality of sample Euclidean distance thresholds. The labels may include an actual resolution quality value corresponding to each sample Euclidean distance threshold. The overall difference degree of the sample may be obtained based on a historical remote sensing image, and more descriptions of the process of obtaining the overall difference degree of the sample may be found in the above process of obtaining the overall difference degree of the sample; the sample Euclidean distance thresholds may be obtained based on the historical Euclidean distance thresholds in the historical classification results when the classification results satisfy the classification requirement, by randomly varying (e.g., by keeping the same, adjusting upward by 0.1, adjusting downward by 0.05, etc.); the resolution quality value corresponding to each sample Euclidean distance threshold may be obtained based on the historical classification results, and the label is 1 in response to that the classification results satisfy all of the specified classification types required in the classification requirement; otherwise, the value of the label is increased or decreased in accordance with a ratio of the classification results that satisfy the specified classification types required in the classification requirement.

In some embodiments, the processor may obtain the training samples with labels based on historical data; and perform a plurality of rounds of iterations, the at least one round of iterations including: selecting one or more training samples from the set of training samples, inputting the one or more training samples into the display model, obtaining a model prediction output corresponding to the one or more training samples; calculating a value of the loss function based on the model prediction output corresponding to the one or more training samples and the labels corresponding to the one or more training samples by substituting them into a formula for a predefined loss function; based on the value of the loss function, iteratively updating a model parameter of the display model in the reverse direction, and completing the training of the model when a preset condition is met, obtaining a trained display model. The preset condition may be the loss function converges, a count of iterations meets a preset count of thresholds, or the like.

In some embodiments, the training of the display model may include determining different sets of training samples and corresponding labels of the training samples based on the count of specified classification types; and performing training on the different sets of training samples according to their size. For example, the processor may divide different training sets for model training based on the count of specified classification types. In some embodiments, the processor may determine different learning rates based on different training sets. For example, the greater the count of specified classification types, the greater the learning rate. The learning rate refers to a hyperparameter in the machine learning model that controls a step size of the model parameter update, which determines a magnitude of the parameter adjustment in each iteration.

In some embodiments of the present disclosure, by introducing the machine learning model (e.g., the display model) to determine the Euclidean distance thresholds corresponding to remote sensing images of different predicted classification types, the thresholds can be dynamically adjusted according to the classification requirement and the overall difference degree of the pixels, to improve the accuracy and adaptability of the classification, and to better satisfy classification needs in different scenarios.

S230: controlling, based on the plurality of different Euclidean distance thresholds, an image classification device to perform the iterative self-organizing classification on the preprocessed remote sensing image, and obtaining the remote sensing image classification results.

In some embodiments, the processor may, based on a plurality of different Euclidean distance thresholds, through a first preset program, automatically generate control instructions and send the control instructions to the image classification device for controlling the image classification device to perform iterative self-organizing classification of the preprocessed remote sensing image. The first preset program may be set in advance by a person skilled in the art. More descriptions of the image classification device may be found in the related description below. More descriptions of the iterative self-organizing classification may be found in FIG. 1 and related descriptions.

S240: determining, based on the remote sensing image classification results, a resolution combination corresponding to a plurality of different types of the remote sensing image classification results, and displaying, by a display device, the remote sensing image classification results based on the resolution combination.

The resolution combination refers to a collection of a plurality of display resolutions set for different types of remote sensing image classification results. In some embodiments, the processor may set resolutions of the different types of remote sensing image classification results separately and combine the resolutions based on historical experience, to obtain a plurality of resolution combinations corresponding to the different types of remote sensing image classification results.

The display device configured to display remote sensing image classification results in a visualized form, such as a computer monitor, a projector, a touch screen, or the like.

In some embodiments, the processor may generate automatically, based on the resolution combinations corresponding to the plurality of different types of remote sensing image classification results, through a second preset program, display instructions and send the display instructions to the display device to control the display device to display, based on the resolution combinations, the remote sensing image classification results to highlight key contents.

In some embodiments of the present disclosure, the plurality of different Euclidean distance thresholds are dynamically determined by comprehensively considering the overall difference degree between different types of pixels in the remote sensing image and the classification requirement, to target the remote sensing images with different predicted classification types, enabling more accurate and personalized iterative self-organizing classification of remote sensing images with different predicted classification types. In addition, the method further determines the resolution combinations that match different predicted classification types based on the classification results, and displays the classification results in the resolution combinations via the display device, which not only improves the accuracy and adaptability but also optimizes the visualization effect of the classification results, providing stronger support for subsequent analysis and decision-making.

In some embodiments, the processor may determine an updated control parameter, based on the remote sensing image classification results; and control, based on the updated control parameter, an image acquisition device to fly at an updated flight speed to an updated flight altitude.

The control parameter refers to a parameter configured to control a flight state of the image acquisition device. In some embodiments, the control parameter may include a flight altitude and a flight speed.

In some embodiments, the processor may determine, based on a plurality of remote sensing image classification results for the same geographic region, an overall difference degree between different types of pixels of each preprocessed remote sensing image; and determine, in response to the overall difference degree being greater than a preset difference threshold, the updated control parameter based on the overall difference degree and a historical control record of the image acquisition device. The preset difference threshold may be set by a person skilled in the art based on experience.

In some embodiments, the processor may calculate the adjusted control parameters based on the historical control parameter in the historical control record that has a distance less than a preset distance value from the overall difference degree and whose remote sensing image classification results meet the classification requirement. The historical control record may be obtained directly from the memory of the image acquisition device. The preset distance value may be set by a person skilled in the art based on experience. An exemplary equation for calculating the distance includes:

$$U = {U}_{h} \times ( 1 - 0 ) ;$$

U is the adjusted control parameter; Uₕ is the historical control parameter; O is the overall difference degree.

The historical control record refers to a past usage record of the image acquisition device. In some embodiments, the historical control record includes historical control parameters. More descriptions of the overall difference degree may be found in the related description above.

In some embodiments of the present disclosure, by dynamically adjusting the flight altitude and the flight speed of the image acquisition device based on the remote sensing image classification results, which enables the image acquisition device to more accurately locate and monitor the target area in a subsequent mission, thereby improving the mission execution efficiency and accuracy, and enhancing the overall performance of the remote sensing monitoring system.

In some embodiments, the processor may determine an area and a location of a fire risk region based on the remote sensing image classification results; determine an inspection path and an inspection speed of an inspection device based on the area and the location of the fire risk region; and control the inspection device to inspect the fire risk region at the inspection speed based on the inspection path.

The fire risk region refers to a geographic region prone to fires identified through remote sensing image data. More descriptions of the remote sensing image data may be found in the previous description.

In some embodiments, the processor may identify, based on the remote sensing image classification results, a region with a preset classification type of a preset type as a fire risk region; and utilize, based on the preprocessed remote sensing image, techniques such as image recognition to further obtain the area and location of the fire risk region. The preset type may be set in advance by a person skilled in the art based on historical fire event records, such as the grassland, the forest, or the like.

The inspection device refers to an automated device configured to periodically inspect and monitor a specific region or facility.

In some embodiments, the processor may determine the inspection path for the inspection device based on the principle of shortest inspection path. In some embodiments, the processor may also determine the inspection path for the inspection device based on the historical inspection data by taking the shortest historical inspection path among a plurality of historical inspection paths when the inspection device inspects against the same geographic area and the inspection is successful (e.g., the inspection device does not malfunction, or the like).

In some embodiments, the processor may, based on the historical inspection data, determine an average of a plurality of historical inspection speeds of the inspection device when the inspection device conducts an inspection against the same geographic area and the inspection is successful, as the inspection speed of the inspection device.

In some embodiments of the present disclosure, by accurately determining the area and the location of the fire risk region based on the remote sensing image classification results, and accordingly reasonably planning the inspection paths and speeds of the inspection device, the efficiency and accuracy of the fire monitoring can be significantly improved. This method ensures the optimal allocation of inspection resources, enabling the inspection device to more effectively cover critical areas and discover potential fire hazards in a timely manner to enhance fire prevention and control capabilities and reduce the losses caused by fire.

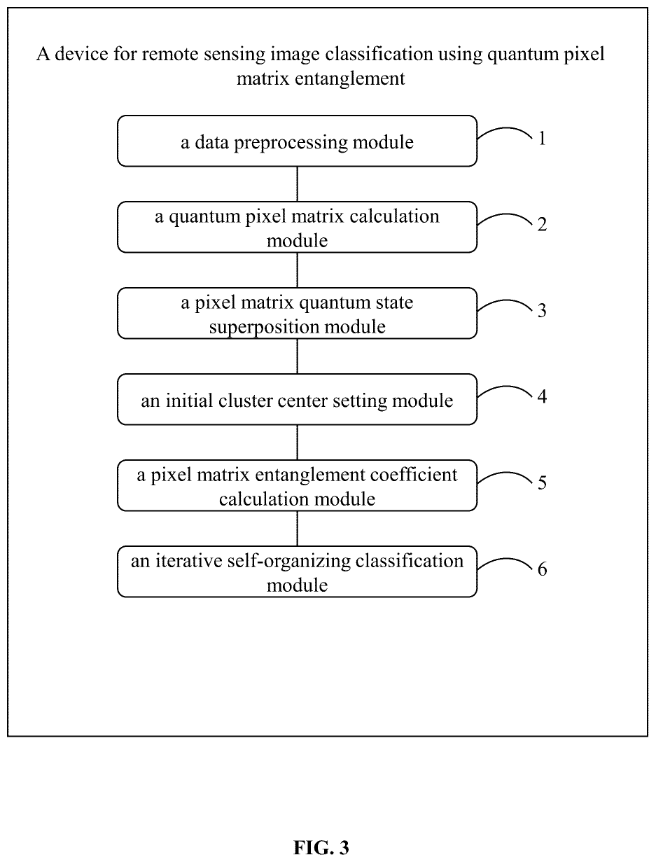

FIG. 3 is a block diagram illustrating a structure of a device for remote sensing image classification using quantum pixel matrix entanglement according to some embodiments of the present disclosure.

Some embodiments of the present disclosure also provide a device for remote sensing image classification using quantum pixel matrix entanglement (hereinafter referred to as an image classification device). As shown in FIG. 3, the image classification device includes:
a data preprocessing module 1 configured to preprocess an acquired raw remote sensing image to obtain remote sensing image data containing multiband fusion;
a quantum pixel matrix calculation module 2 (which may be referred to as a matrix calculation module) configured to calculate, based on the preprocessed remote sensing image, quantum states |ϕₚ [symbol] of pixel matrices corresponding to images of individual bands;
a pixel matrix quantum state superposition module 3 (which may be referred to simply as a quantum state superposition module) configured to calculate superposition states |ϕ [symbol] of the quantum states of the pixel matrices of the individual bands based on a count of bands u in the raw remote sensing image.
an initial cluster center setting module 4 (which may be referred to as a cluster center setting module) configured to randomly select K pixel matrices as the initial cluster centers K_{C}, for an iterative self-organizing classification according to a classification requirement;
a pixel matrix entanglement coefficient calculation module 5 (which may be referred to as an entanglement coefficient calculation module) configured to calculate a pixel matrix entanglement coefficient μ between a cluster center and the other pixel matrices based on the cluster center;
an iterative self-organizing classification module 6 (which may be referred to as a self-organizing classification module) configured to calculate, based on the cluster center, the pixel matrix entanglement coefficient μ and a Euclidean distance d between the cluster center and the other pixel matrices, and perform the iterative self-organizing classification of remote sensing image data based on the pixel matrix entanglement coefficient and a Euclidean distance threshold to obtain remote sensing image classification results.

In some embodiments, a self-organizing classification module includes:
a Euclidean distance calculation module (which may be referred to as a distance calculation module) configured to calculate a Euclidean distance d between the cluster center and the other pixel matrices based on the cluster center;
a Euclidean distance threshold determination module (which may be referred to as a threshold determination module) configured to determine the Euclidean distance threshold based on the classification requirement;
a classification module configured to perform an iterative self-organizing classification of remote sensing image data based on a pixel matrix entanglement coefficient and the Euclidean distance threshold, combine pixel matrices with the pixel matrix entanglement coefficient μ of the preprocessed remote sensing image being 0 and the Euclidean distance d being less than a Euclidean distance threshold d′ into a class for performing the iterative self-organizing classification, update the cluster center, and repeat the iterative self-organizing classification until the iterative convergence, and to obtain the remote sensing image classification results.

In some embodiments, the image classification device further includes:
a first control module configured to determine an updated control parameter based on the remote sensing image classification results, wherein the control parameter includes a flight altitude and a flight speed; and control, based on the updated control parameter, an image acquisition device to fly at an updated flight speed to an updated flight altitude.

In some embodiments, the image classification device further includes:
a second control module configured to determine an area and a location of a fire risk region based on the remote sensing image classification results; determine an inspection path and an inspection speed of an inspection device based on the area and the location of the fire risk region; and control the inspection device to inspect the fire risk region at the inspection speed based on the inspection path.

Some embodiments of the present disclosure further provide a computer-readable storage medium, the computer-readable storage medium storing program codes, when the program codes are executed by a processor, a method for remote sensing image classification using quantum pixel matrix entanglement is realized.

Computer-readable storage media may be a tangible device that maintains and stores instructions used by an instruction execution device. The computer-readable storage medium may be but is not limited to, an electrical storage device, a magnetic storage device, an optical storage device, an electromagnetic storage device, a semiconductor storage device, or any combination of the foregoing.

Some embodiments of the present disclosure further provide an electronic processing device corresponding to the aforementioned remote sensing image classification method of quantum pixel matrix entanglement, and the electronic processing device may be a processing device for use on a client side, such as a cellular phone, a laptop computer, a tablet computer, desktop computer, or the like, to perform the method for remote sensing image classification using quantum pixel matrix entanglement, without limitation herein.

The processing device includes a processor, a memory, a communication interface, and a bus, and the processor, the memory, and the communication interface are connected via the bus to accomplish communication with each other. The memory stores a computer program that can be run on the processor, and the processor runs the computer program to execute the method for remote sensing image classification using quantum pixel matrix entanglement.

The basic concepts have been described above, and it is apparent to those skilled in the art that the foregoing detailed disclosure serves only as an example and does not constitute a limitation of this specification. While not expressly stated herein, a person skilled in the art may make various modifications, improvements, and amendments to this specification. Those types of modifications, improvements, and amendments are suggested in this specification, so those types of modifications, improvements, and amendments remain within the spirit and scope of the exemplary embodiments of this specification.

What is claimed is:

1. A method for remote sensing image classification using quantum pixel matrix entanglement, comprising:
preprocessing an acquired raw remote sensing image to obtain image data containing multiband fusion; and
calculating a pixel matrix entanglement coefficient μ and a Euclidean distance d between a cluster center and other pixel matrices based on a preprocessed remote sensing image, performing an iterative self-organizing classification on remote sensing image data based on the pixel matrix entanglement coefficient and a Euclidean distance threshold, and obtaining remote sensing image classification results.

2. The method of claim 1, wherein the preprocessing the acquired raw remote sensing image includes radiometric correction, atmospheric correction, geometric correction, image cropping, and image fusion.

3. The method of claim 1, wherein the calculating a pixel matrix entanglement coefficient μ and a Euclidean distance d between a cluster center and other pixel matrices based on a preprocessed remote sensing image, performing an iterative self-organizing classification on remote sensing image data based on the pixel matrix entanglement coefficient and a Euclidean distance threshold, and obtaining remote sensing image classification results further includes:
calculating, based on the preprocessed remote sensing image, quantum states of pixel matrices corresponding to images of individual bands, and calculating a superposition state of the quantum states of the pixel matrices of the individual bands based on a count of bands in the raw remote sensing image;
determining a count of classes of classified features based on a classification requirement of the remote sensing image; and
performing, based on the count of classes of classified features, the iterative self-organizing classification on the remote sensing image data to obtain the remote sensing image classification results.

4. The method of claim 3, wherein the calculating, based on the preprocessed remote sensing image, quantum states of pixel matrices corresponding to images of individual bands, and calculating a superposition state of the quantum states of the pixel matrices the individual bands based on a count of bands in the raw remote sensing image further includes:
starting from a pixel of the preprocessed remote sensing image, transforming all pixels into quantum pixel matrices under three-dimensional orthogonal basis vectors in a Hilbert space, and calculating a corresponding quantum state |ϕₚ [symbol] ;
calculating, based on a quantum state |ϕₚ [symbol] of each pixel matrix, a correspondence between the quantum state |ϕₚ [symbol] of the each pixel matrix and a red grayscale value G_{R}, a green grayscale value G_{G}, and a blue grayscale value G_{B} of the each pixel matrix;
determining a count of bands u in the raw remote sensing image; and
calculating the superposition state |ϕ [symbol] of the quantum states of the pixel matrices of the individual bands based on the count of bands u in the raw remote sensing image.

5. The method of claim 3, wherein the performing, based on the count of classes of classified features, the iterative self-organizing classification on the remote sensing image data to obtain the remote sensing image classification results further includes:
determining an initial cluster center K_{C}, and randomly selecting K pixel matrices as the initial cluster center K_{C};
calculating the pixel matrix entanglement coefficient μ and the Euclidean distance d between the cluster center and the other pixel matrices based on the initial cluster center K_{C};
determining the Euclidean distance threshold based on the classification requirement;
combining pixel matrices with the pixel matrix entanglement coefficient μ of the preprocessed remote sensing image being 0 and the Euclidean distance d being less than a Euclidean distance threshold d′ into a class for performing the iterative self-organizing classification;
updating the cluster center based on a result of the iterative self-organizing classification; and
repeating the iterative self-organizing classification until iterations converge to achieve the classification of the remote sensing image.

6. The method of claim 5, further comprising:
determining an overall difference degree of different types of pixels of the preprocessed remote sensing image;
determining a plurality of different Euclidean distance thresholds based on the classification requirement and the overall difference degree; wherein the plurality of different Euclidean distance thresholds correspond to a plurality of different preprocessed remote sensing images;
controlling, based on the plurality of different Euclidean distance thresholds, an image classification device to perform the iterative self-organizing classification on the preprocessed remote sensing image, and obtaining the remote sensing image classification results; and
determining, based on the remote sensing image classification results, a resolution combination corresponding to a plurality of different types of the remote sensing image classification results, and displaying, by a display device, the remote sensing image classification results based on the resolution combination.

7. The method of claim 6, wherein the determining a plurality of different Euclidean distance thresholds based on the classification requirement and the overall difference degree further includes:
for each preprocessed remote sensing image,
determining a resolution quality value of the plurality of preset distance thresholds by a display model based on the classification requirement, the overall difference degree, and the plurality of preset distance thresholds; the display model being a machine learning model; and
determining the Euclidean distance threshold corresponding to the preprocessed remote sensing image based on the resolution quality value.

8. The method of claim 7, wherein the plurality of preset distance thresholds are determined based on historical classification results.

9. The method of claim 7, wherein a training of the display model includes:
determining different sets of training samples and corresponding labels of the training samples based on a count of specified classification types; and
performing training on the different sets of training samples according to their size.

10. The method of claim 5, wherein the determining an initial cluster center K_{C} further includes:
determining, based on the preprocessed remote sensing image, a red grayscale value, a green grayscale value, and a blue grayscale value of the each pixel matrix in the preprocessed remote sensing image;
determining a ratio of different types of pixels of the preprocessed remote sensing image based on the red grayscale value, the green grayscale value, and the blue grayscale value of the each pixel matrix; and
determining a count of updated initial cluster center K_{C} based on the ratio of the different types of pixels;
the method further comprising:
controlling an image classification device to perform the iterative self-organizing classification on the preprocessed remote sensing image based on the count of updated initial cluster center K_{C}.

11. The method of claim 10, wherein the determining a count of an updated initial cluster center K_{C} based on the ratio of the different types of pixels further includes:
sorting in descending order based on the ratio of the different types of pixels; and
designating a count of predicted classification types whose ordering is prior to a preset ranking as the count of updated initial cluster center K_{C} based on the classification requirement.

12. The method of claim 10, wherein the count of pixel types is related to an image richness degree of the preprocessed remote sensing image; and the pixel types are determined based on historical classification results.

13. The method of claim 1, further comprising:
determining an updated control parameter based on the remote sensing image classification results, the control parameter including a flight altitude and a flight speed; and
controlling, based on the updated control parameter, an image acquisition device to fly at an updated flight speed to an updated flight altitude.

14. The method of claim 1, further comprising:
determining an area and a location of a fire risk region based on the remote sensing image classification results;
determining an inspection path and an inspection speed of an inspection device based on the area and the location of the fire risk region; and
controlling the inspection device to inspect the fire risk region at the inspection speed based on the inspection path.

15. A device for remote sensing image classification using quantum pixel matrix entanglement, comprising:
a data preprocessing module configured to preprocess an acquired raw remote sensing image to obtain image data containing multiband fusion;
a matrix computation module configured to calculate, based on the preprocessed remote sensing image, quantum states |ϕₚ [symbol] of pixel matrices corresponding to images of individual bands;
a quantum state superposition module configured to calculate a superposition state |ϕ [symbol] of the quantum states of the pixel matrices of the individual bands based on a count of bands u in the raw remote sensing image;
a cluster center setting module configured to randomly select K pixel matrices as the initial cluster centers K_{C}, for an iterative self-organizing classification according to a classification requirement;
an entanglement coefficient calculation module configured to calculate a pixel matrix entanglement coefficient μ between a cluster center and the other pixel matrices based on the cluster center; and
a self-organizing classification module configured to calculate, based on the cluster center, the pixel matrix entanglement coefficient μ and a Euclidean distance d between the cluster center and the other pixel matrices, and to perform the iterative self-organizing classification of remote sensing image data based on the pixel matrix entanglement coefficient and a Euclidean distance threshold to obtain remote sensing image classification results.

16. The device of claim 15, wherein the self-organizing classification module includes:
a distance calculation module configured to calculate a Euclidean distance d, between the cluster center and the other pixel matrices based on the cluster center;
a threshold determination module configured to determine the Euclidean distance threshold based on the classification requirement; and
a classification module configured to perform the iterative self-organizing classification of the remote sensing image data based on the pixel matrix entanglement coefficient and the Euclidean distance threshold to obtain the remote sensing image classification results.

17. The device of claim 15, further comprising:
a first control module configured to determine an updated control parameter based on the remote sensing image classification results, the control parameter including a flight altitude and a flight speed; and control, based on the updated control parameter, an image acquisition device to fly at an updated flight speed to an updated flight altitude.

18. The device of claim 15, further comprising:
a second control module configured to determine an area and a location of a fire risk region based on the remote sensing image classification results; determine an inspection path and an inspection speed of an inspection device based on the area and the location of the fire risk region; and control the inspection device to inspect the fire risk region at the inspection speed based on the inspection path.

19. A computer-readable storage medium, the computer-readable storage medium storing program codes, when the program codes are executed by a processor, a method for remote sensing image classification using quantum pixel matrix entanglement is realized, wherein the method comprises:
preprocessing an acquired raw remote sensing image to obtain image data containing multiband fusion; and
calculating a pixel matrix entanglement coefficient μ and a Euclidean distance d between a cluster center and other pixel matrices based on a preprocessed remote sensing image, performing an iterative self-organizing classification on remote sensing image data based on the pixel matrix entanglement coefficient and a Euclidean distance threshold, and obtaining remote sensing image classification results.
